(19) United States
(12) Patent Application Publication
(10) Pub. No.: US 2019/0099026 A1
(43) Pub. Date: Apr. 4, 2019

(54) MOUNTABLE BEVERAGE-CONTAINER HOLDER

(71) Applicant: Reey YADIN, Toronto (CA)

(72) Inventor: Reey YADIN, Toronto (CA)

(21) Appl. No.: 15/960,014

(22) Filed: Apr. 23, 2018

Related U.S. Application Data
(60) Provisional application No. 62/602,966, filed on May 15, 2017.

(51) Int. Cl. A47G 23/02; B60N 3/10

(52) U.S. Cl. CPC A47G 23/0225; F16M 13/02; B60N 3/103

(57) ABSTRACT

A beverage-container holder and method for removably mounting such holder to a fixed object for holding of a beverage-container. The beverage-container holder includes: a first member comprising a first front arm, a first hub, and a first rear arm; a second member comprising a second front arm, a second hub, and a second rear arm; a fastener for rotatably adjoining the first hub to the second hub, a front channel for receiving the beverage-container when the beverage-container holder is mounted on the fixed object, a rear channel for receiving the fixed object; a mechanical bias forcing the first front arm and the second front arm rearwards, the first rear arm separating from the second rear arm and defining a space therebetween when a manual force is applied, and passing the fixed object through the space into the rear channel and releasing of the manual force.

### TECHNICAL FIELD

The following relates generally to beverage-container accessories, and more specifically, to a mountable beverage-container holder and method for removably mounting a beverage-container holder.

### BACKGROUND

Due to people's modern busy lives, people often enjoy consuming a beverage while commuting or travelling; for example, consuming coffee, tea, juice, soda, water, or the like. People also like to consume beverages while they do other activities. For many people in these situations, such as those who commute or travel via public or shared transportation, there is often no adequate way to rest their beverage-container, such as via a beverage-container holder. As such, for example, people riding public transportation often have to forgo bringing their beverages during their trip, or have to hold their beverage-container precariously while riding a public or shared transportation vehicle. Having to hold their beverage-container in the vehicle typically means that the beverage-container is more likely to spill, and typically means that a person cannot conduct another activity, such as reading, due to their hands and/or cognition being consumed by holding the beverage-container.

### SUMMARY

In an aspect, there is provided a beverage-container holder removably mountable to a fixed object for holding of a beverage-container, the beverage-container holder comprising: a first member comprising a first front arm, a first hub, and a first rear arm; a complementary second member comprising a second front arm, a second hub, and a second rear arm; a fastener for rotatably adjoining the first hub to the second hub such that the first front arm horizontally opposes the second front arm forming a front channel therebetween for receiving the beverage-container when the beverage-container holder is mounted on the fixed object, and such that the first rear arm horizontally opposes the second rear arm forming a rear channel therebetween for receiving the fixed object; a mechanical bias forcing the first front arm and the second front arm rearwards such that the first rear arm moves towards the second rear arm, the first rear arm separating from the second rear arm and defining a space therebetween when a manual force is applied to rotate the first front arm towards the second front arm against the mechanical bias, the beverage-container holder mountable on the fixed object by positioning the beverage-container holder such that the fixed object passes through the space into the rear channel, and releasing of the manual force to allow the front channel to receive the beverage container.

In a particular case, the beverage-container holder is dismountable from the fixed object when the front channel is no longer receiving the beverage-container and a manual force is applied to rotate the first front arm towards the second front arm against the mechanical bias and the beverage-container is pulled away away from the fixed object such that the fixed object passes through the space out of the rear channel.

In another case, the first rear arm and the second rear arm have a substantially arcuate shape.

In yet another case, the fixed object has a substantially cylindrical shape and wherein the first rear arm and the second rear arm form the rear channel with a substantially circular profile.

In yet another case, the first rear arm comprises one or more first fingers and the second rear arm comprises one or more second fingers, and wherein the first fingers are interlocking with the second fingers.

In yet another case, the first front arm and the second front arm have a substantially arcuate shape.

In yet another case, the first front arm has a gradual upward profile along the vertical and the second front arm has a gradual downward profile along the vertical.

In yet another case, the first front arm and the second front arm form the rear channel having a downwards pointing substantially conical profile.

In yet another case, the first member comprises a single integral member and the second member comprises a separate single integral member.

In yet another case, the mechanical bias comprises a torsion spring.

In yet another case, the torsion spring having a spring rate of between approximately 0.1 inch-lbs/degree and 0.2 inch-lbs/degree.

In yet another case, the first front arm and the second front arm, the first rear arm and the second rear arm, or both, comprise a high-friction material.

In yet another case, the first front arm and the second front arm each comprise at least one hinge such that the first front arm and the second front arm are collapsible.

In yet another case, the first front arm and the second front arm each comprise a support structure for providing support against forces experienced by the first front arm and the second front arm.

In yet another case, the support structure comprises one or more transverse ribs.

In another aspect, there is provided a method for removably mounting a beverage-container holder to a fixed object to hold a beverage-container, the method comprising: mounting the beverage-container holder to the fixed object, comprising: applying a manual force to rotate a first front arm of a first member towards a second front arm of a second member against a mechanical bias to create a space between a first rear arm of the first member and a second rear arm of the second member, the first front arm horizontally opposes the second front arm forming a front channel therebetween, the first rear arm horizontally opposes the second rear arm forming a rear channel therebetween, the rotation about a pivot comprising a first hub of the first member adjoined to a second hub of the second member; positioning the beverage-container holder such that the fixed object passes through the space and in to the rear channel; releasing of the manual force; and receiving a beverage-container in the front channel; and dismounting the beverage-container holder from the fixed object, comprising: removing the beverage-container from the front channel; applying a manual force to rotate the first front arm towards the second front arm against the mechanical bias to create the space between the first rear arm and the second rear arm; and positioning the beverage-container holder such that the fixed object passes through the space and out of the rear channel.

In a particular case, the method further comprising increasing the clamping force of the first rear arm and the second rear arm against the fixed object when the front channel receives the beverage-container having a tapered profile.

In another case, the fixed object has a cylindrical profile, and the method further comprises automatically adjusting the diameter of the rear channel to the size of the fixed object.

In yet another case, applying the manual force to rotate the first front arm towards the second front arm twists against the force of the mechanical bias, the mechanical bias being a torsion spring.

In yet another case, mounting the beverage-container holder to the fixed object further comprising opening a collapsible portion of each of the first front arm and the second front arm.

These and other aspects are contemplated and described herein. It will be appreciated that the foregoing summary sets out representative aspects of the method and beverage-container holder to assist skilled readers in understanding the following detailed description.

### DESCRIPTION OF THE DRAWINGS

A greater understanding of the embodiments will be had with reference to the Figures, in which:

FIG. 1A illustrates a front view of a mountable beverage-container holder, according to an embodiment;

FIG. 1B illustrates a partial front view of the mountable beverage-container holder of FIG. 1A;

FIG. 1C illustrates a top view of the mountable beverage-container holder of FIG. 1A;

FIG. 1D illustrates a partial side view of the mountable beverage-container holder of FIG. 1A;

FIG. 1E illustrates a rear view of the mountable beverage-container holder of FIG. 1A;

FIG. 2A illustrates a side view of the mountable beverage-container holder of FIG. 1A mounted to a fixed object;

FIG. 2B illustrates a rear view of the mountable beverage-container holder of FIG. 1A mounted to the fixed object;

FIG. 3A is a front perspective illustration of the mountable beverage-container holder of FIG. 1A mounted to the fixed object holding a beverage container;

FIG. 3B is a rear perspective illustration of the mountable beverage-container holder of FIG. 1A mounted to the fixed object holding the beverage container;

FIG. 4 is a flowchart of a method for removable mounting a beverage-container holder, according to an embodiment;

FIG. 5 illustrates a top view of a mountable beverage-container holder, according to another embodiment;

FIG. 6A illustrates a front view of a mountable beverage-container holder, according to another embodiment;

FIG. 6B illustrates a partial front view of the mountable beverage-container holder of FIG. 6A;

FIG. 7 illustrates a perspective view of the mountable beverage-container holder of FIG. 6A;

FIG. 8 is a perspective illustration of the mountable beverage-container holder of FIG. 1A with a manual force applied in anticipation of being mounted on the fixed object; and

FIG. 9 is a perspective illustration of the mountable beverage-container holder of FIG. 1A in the act of being mounted on the fixed object.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The following relates generally to beverage-container holders, and more specifically, to a mountable beverage-container holder and method for removably mounting a beverage-container holder. Illustrative embodiments of the mountable beverage-container holder and method of mounting a beverage-container holder disclosed herein will now be described in detail with reference to the figures. It is contemplated that the beverage-container referred to herein can include any suitable receptacle for a liquid; for example, disposable or reusable cups for hot or cold liquids, insulated containers such as a Thermos™, disposable or reusable water bottles, consumer bottles such as a cola bottle, glass bottles, or the like.

The mountable beverage-container holder of the embodiments described herein allows users to mount a beverage-container holder to a fixed object, in places traditionally bereft of beverage-container holders or without convenient beverage-container access. For example, a fixed object in a vehicle, a fixed object at a construction site, a portion of a bicycle, a fixed lamp post in a household, and the like. In a particular case, the fixed object being a pole, for example, poles, handrails, or stanchions typically found in subways, streetcars, and buses. In other cases, the fixed object can be other elements of the vehicle; for example, rails, projections, headrests, air registers, seat legs or posts, handles, or the like. Advantageously, the mountable beverage-container holder allows a person to rest their beverage-container securely while they are travelling in the vehicle; particularly, when travelling in that vehicle does not typically allow the person the use of a conventional beverage-container holder. Also advantageously, the mountable beverage-container holder is portable and allows the person to mount the beverage-container holder locally around them when they arrive in the vehicle, and remove and store the beverage-container holder when they depart the vehicle.

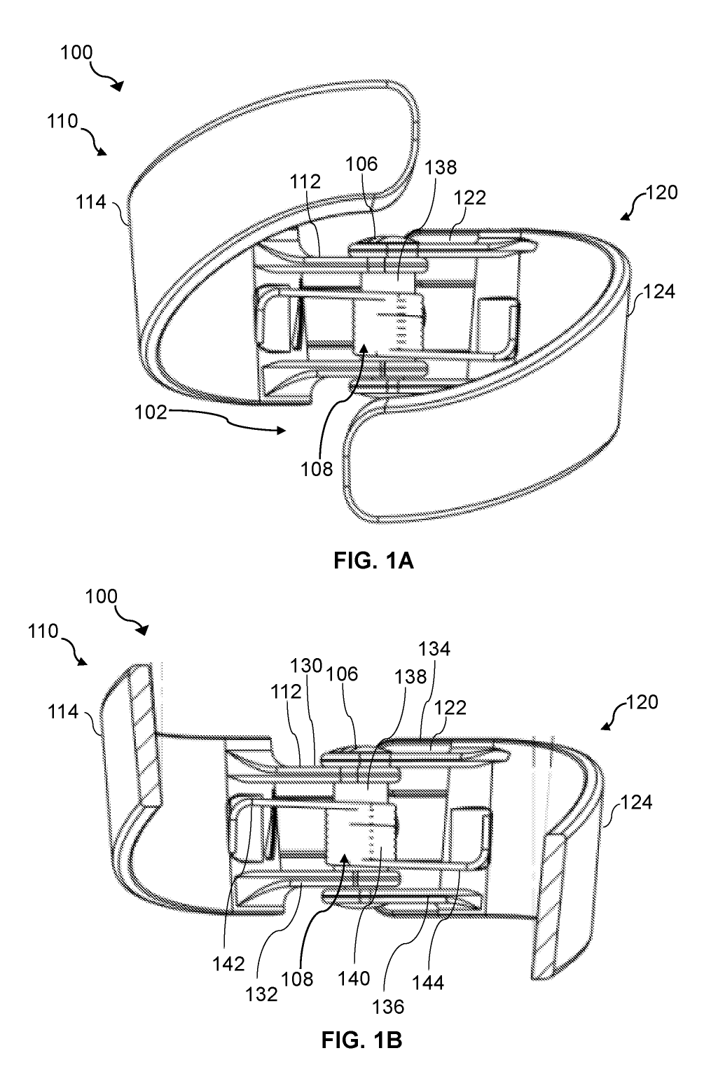

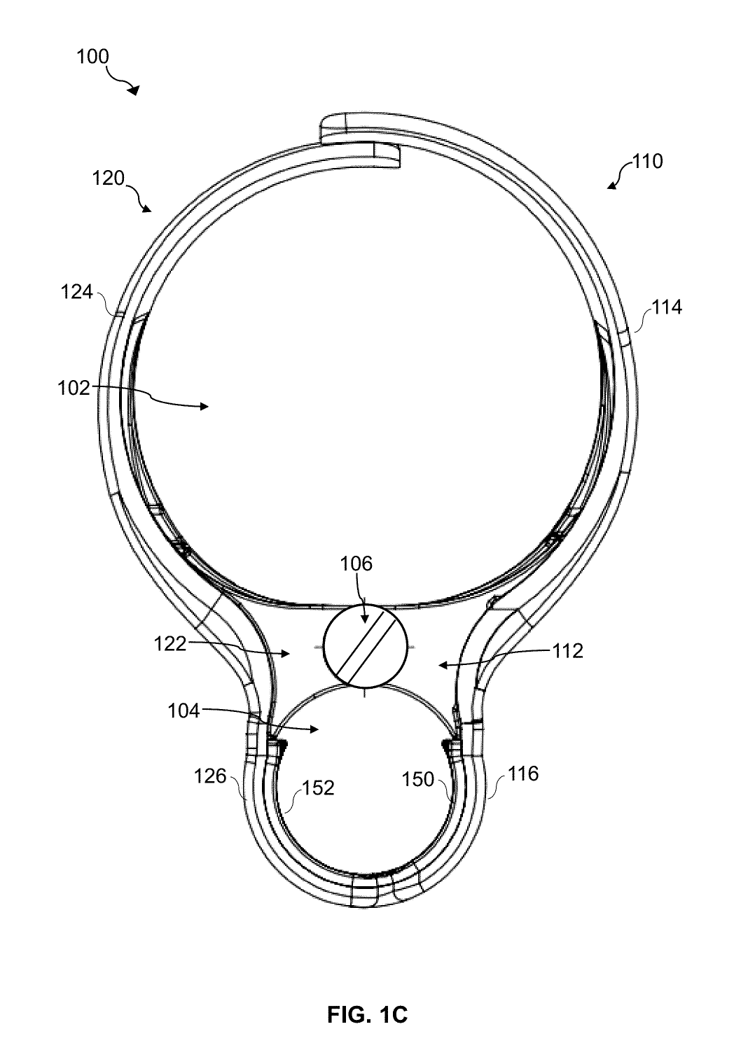

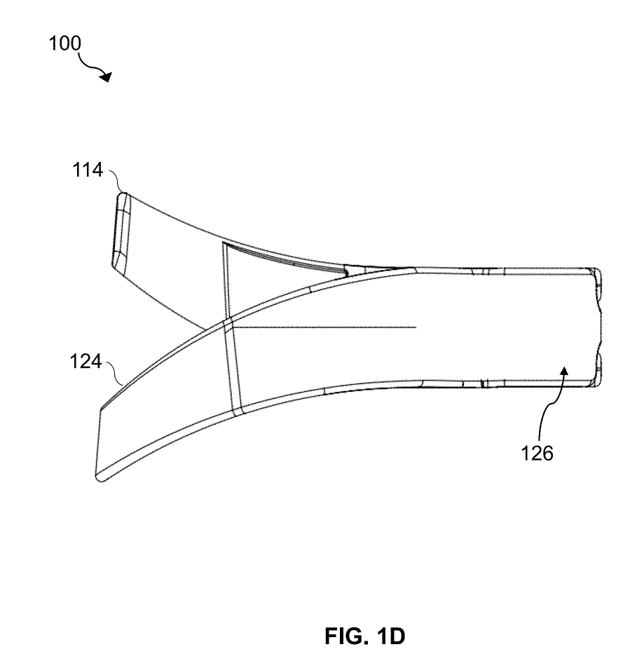

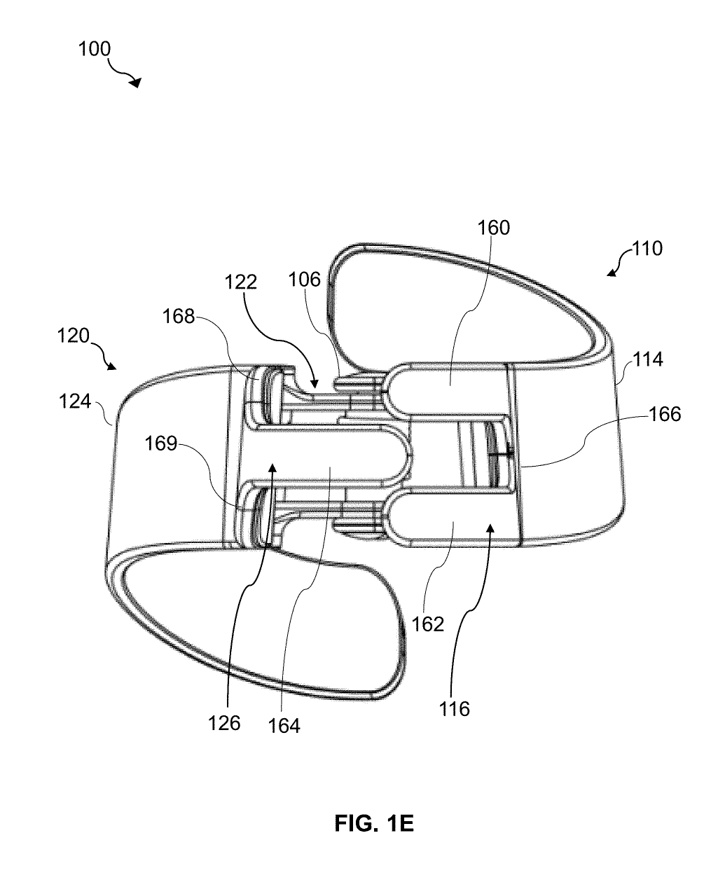

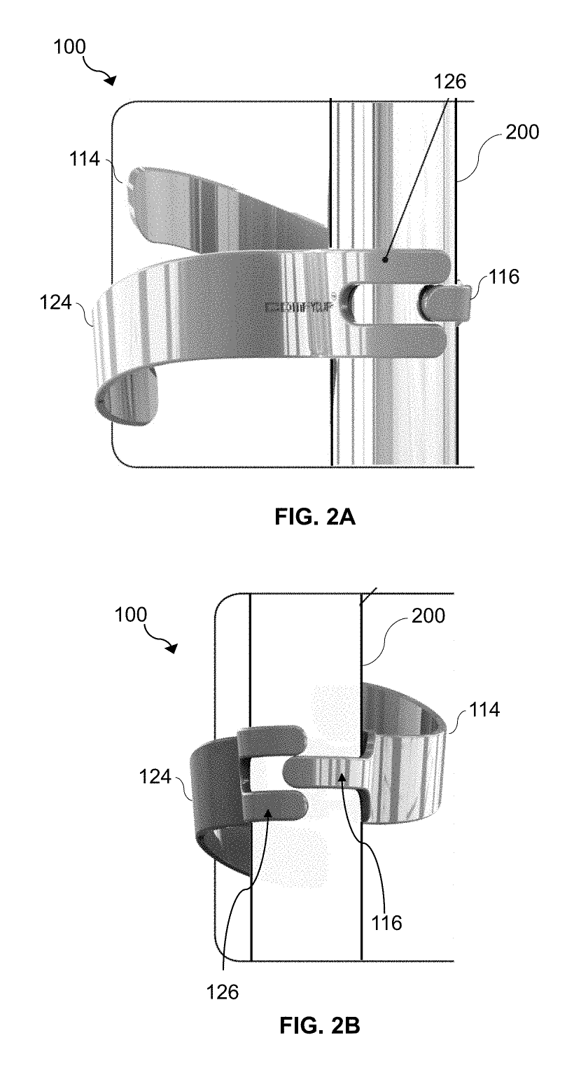

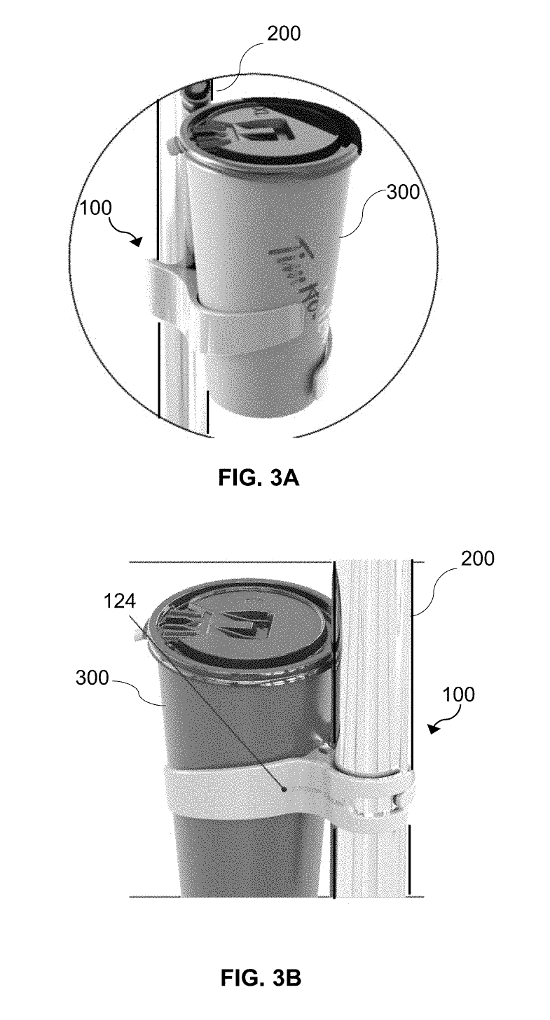

FIGS. 1A to 1E illustrate a mountable beverage-container holder 100, according to an embodiment. FIGS. 2A and 2B illustrate the mountable beverage-container holder 100 mounted on a fixed object 200. FIGS. 3A and 3B illustrate the mountable beverage-container holder 100 holding a beverage-container 300 and mounted on the fixed-object 200. As illustrated, the mountable beverage-container holder 100 includes a first member 110 and a complementary second member 120. The first member 110 includes a first hub 112, a first front arm 114 extending frontwards from the first hub 112, and a first rear arm 116 extending rearwards from the first hub 112. The second member 120 includes a second hub 122, a second front arm 124 extending frontwards from the second hub 122, and a second rear arm 126 extending rearwards from the second hub 122.

As best illustrated in FIG. 1B, the first hub 112 and the second hub 122 cooperate to rotate around a pivot point. In the present embodiment, the first hub 112 and the second hub 122 are in an overlapping arrangement, defining a passageway therethrough in which a fastener 106 (or post) is positioned; the fastener 106 forming the pivot point. In the present embodiment, the first hub 112 includes a first upper platform 130 and a first lower platform 132, while the second hub 122 includes a second upper platform 134 and a second lower platform 136. The first upper platform 130 and the first lower platform 132 intertwining with the second upper platform 134 and the second lower platform 136 such that holes defined in each of the platforms 130, 132, 134, 136 line up to form the passageway. In some cases, a hub cylinder 138 is positioned intermediate the upper platforms 130, 134 and the lower platforms 132, 136, having an interior cylinder channel in-line with the passageway to permit the fastener 106 to pass therethrough.

The mountable beverage-container holder 100 further includes a mechanical bias 108 for biasing the beverage-container holder 100 into an open configuration by forcing the first front arm 114 and the second front arm 124 in the rearward direction, as described herein. In the present embodiment, the mechanical bias 108 is a torsion spring having a coiled portion 140 positioned around the hub cylinder 138. The mechanical bias 108 also includes a first spring arm 142 abutting and applying a force against an interior portion of the first front arm 114, and a second spring arm 144 abutting and applying a force against an interior portion of the second front arm 124.

The mechanical bias 108 is configured to have a biasing force that is large enough to securely mount the mountable beverage-container holder 100 onto the fixed object 200, but small enough to allow manual movement of the first front arm 114 and the second front arm 124 without substantial difficulty. In some cases, the mechanical bias 108 can have a force equivalent to a torsion spring rate of between approximately 0.1 inch-lbs/degree and 0.2 inch-lbs/degree; and in a particular case, can be equivalent to a torsion spring rate of approximately 0.14 inch-lbs/degree.

In further embodiments, the mechanical bias 108 can be, for example, a compression spring located intermediate the first front arm 114 and the second front arm 124, an electronic servo intermediate the first front arm 114 and the second front arm 124, or the like. In further embodiments, the mechanical bias 108 can be integral to the material of the first member 110 and the second member 120; for example, such as making at least a portion of the first member 110 and the second member 120 out of a flexible polymer or flexible metal.

In the present embodiments, the first member 110 and the second member 120 are comprised out of material that is light but strong and resilient enough to withstand the forces of the mechanical bias 108 and manual forces. In an example, the first member 110 and the second member 120 are comprised out of, at least substantially, poly-carbonate, polyvinyl chloride, titanium, stainless steel, or the like. In the present embodiments, the fastener 106 is comprised out of material that is light but strong and resilient enough to withstand the forces applied via the first hub 112 and the second hub 122, and the mechanical bias 108. In an example, the mechanical bias can be comprised of stainless steel, titanium, or the like.

As best illustrated in FIG. 10, the first front arm 114 and the second front arm 124 each have complementary arcuate shapes such that in a closed configuration the first front arm 114 and the second front arm 124 define a front channel 102. The first rear arm 116 and the second rear arm 126 each have complementary arcuate shapes such that, in the closed configuration, the first rear arm 116 and the second rear arm 126 define a rear channel 104.

In the present embodiment, as best illustrated in FIG. 10, the first front arm 114 and the second front arm 124 horizontally overlap at the ends of the front arms 114, 124 opposite the hubs 112, 122. In further embodiments, the first front arm 114 and the second front arm 124 do not overlap along the horizontal plane. In some cases, the first front arm 114 and the second front arm 124 only partially extend along the circular path of the front channel 102 such that the front channel 102 is open on the side opposite the hubs 112, 122.

In the present embodiment, as best illustrated in FIGS. 1A and 1D, with respect to the vertical arrangement, the first front arm 114 has a gradual upward profile while the second front arm 124 has a gradual downward profile. Advantageously, it is intended that this arrangement for the first front arm 114 and the second front arm 124 allows for greater stability when grasping the beverage-container 300 because there are more points of contact, and thus greater friction, between the front arms 114, 124 and the beverage-container 300 along the vertical. In some cases, the horizontal radius of the front channel 102 formed by the first front arm 114 and the second front arm 124 can taper along the vertical axis such that the front channel 102 effectively has a downwards pointing substantially conical profile; approximating a tapering profile of the beverage-container.

Advantageously, where the beverage-container has a tapering profile, the weight of the beverage-container will apply a force to outwardly rotate the front arms 114, 124, and by mechanical connection, the rear arms 116, 126 will experience a forced to inwardly rotate, increasing the clamping force against the fixed object 200. Accordingly, the heavier the beverage-container, the stronger the clamping force; which is particularly advantageous because heavier containers are more likely to slide or move a beverage-container holder. It is intended that this effect will be even greater where the front channel 102 also has a tapering profile because there will be more contact of the front arms 116, 126 with the beverage-container, and thus, more force experienced against the front arms 116, 126.

In further embodiments, the first front arm 114 and the second front arm 124 can be arranged along the same, or similar, horizontal plane.

The size of the front channel 102, defined by the first front arm 114 and the second front arm 124, is configured to hold standard sized beverage-containers while in the closed configuration. In some cases, the size of the front channel 102 configured to hold beverage-containers having a graduated circumference, as shown in FIGS. 3A and 3B. In a particular case, the front channel 102 having a radius of approximately 3.5 inches along the horizontal plane. In further cases, the mountable beverage-container holder 100 can come in different variations each having the front channel 102 with a different radius in order to hold various sized beverage-containers.

As best illustrated in FIGS. 2A and 2B, the first rear arm 116 and the second rear arm 126, in the closed configuration, cooperate to securely mount and clamp the mountable beverage-container holder 100 to the fixed object 200. In the present embodiment, as shown in FIG. 1E, the first rear arm 116 comprises a first upper finger 160 and a first lower finger 162, and the second rear arm 126 comprises a second interlocking finger 164. In this arrangement, as the mechanical bias 108 forces the first front arm 114 and the second front arm 124 in the rearward direction, the first rear arm 116 and the second rear arm 126 are brought together until the second interlocking finger 164 is resting against an abutment 166 formed in between the first upper finger 160 and the first lower finger 162. In some cases, they are also brought together until the first upper finger 160 and the first lower finger 162 are resting against abutments above 168 and below 169 the second interlocking finger 164 respectively. Advantageously, the rear arms 116, 126 finger arrangement of the present embodiments allows the rear arms 116, 126 to clamp on to different cylindrical objects having different diameters due to the contact provided by the interlocking nature of the fingers 160, 162, 164. In this way, the rear arms 116, 126 can automatically adjust to the diameter of the fixed object after the manual force is removed because the mechanical bias 108 provides a force that effectively clamps the rear arms 116, 126 to the fixed object; as long as the diameter of the fixed object is equal to or greater than the diameter of the rear channel 104 when the interlocking finger 164 is resting against an abutment 166, and less than the maximum size of the space between the rear arms 116, 126.

In further embodiments, the first rear arm 116 and the second rear arm 126 can have any suitable configuration. For example, each rear arm 116, 126 comprising more fingers or less fingers than in the present configuration, as long as the fingers on the first rear arm 116 interlock with the fingers on the second rear arm 126. In another example, each rear arm 116, 126 comprising a vertical abutment for the first rear arm 116 to abut the second rear arm 126 in the open configuration.

In some cases, the rear channel 104 facing sides of the first rear arm 116 and the second rear arm 126 can have a high-friction coating or material 150, 152 affixed to it; for example, rubber, foam, silicone, grip tape, or the like. Advantageously, this can increase the ‘grip’ of the beverage-container holder 100 against the fixed object such that it is prevented from sliding down the fixed object; especially where the weight of the beverage-container is causing additional downwards force due to gravity. In further cases, the first rear arm 116 and the second rear arm 126 can be at least partially comprised of the high-friction coating or material 150, 152. Likewise, in some cases, the front channel 102 facing sides of the first front arm 114 and the second front arm 124 can have a high-friction coating or material affixed to it; for example, rubber, foam, silicone, grip tape, or the like. In further cases, the first front arm 114 and the second front arm 124, and/or the first rear arm 116 and the second rear arm 126, can be at least partially comprised of the high-friction coating or material. In further cases, the first front arm 114 and the second front arm 124, and/or the first rear arm 116 and the second rear arm 126, can be at least partially comprised of a patterning imprint, patterning embossing, ridges, or the like, to increase friction.

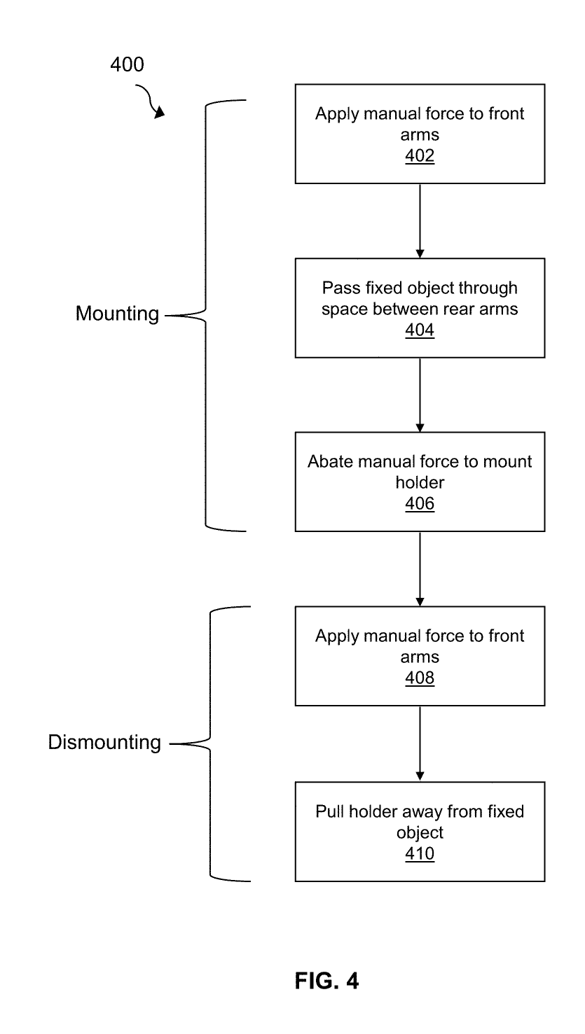

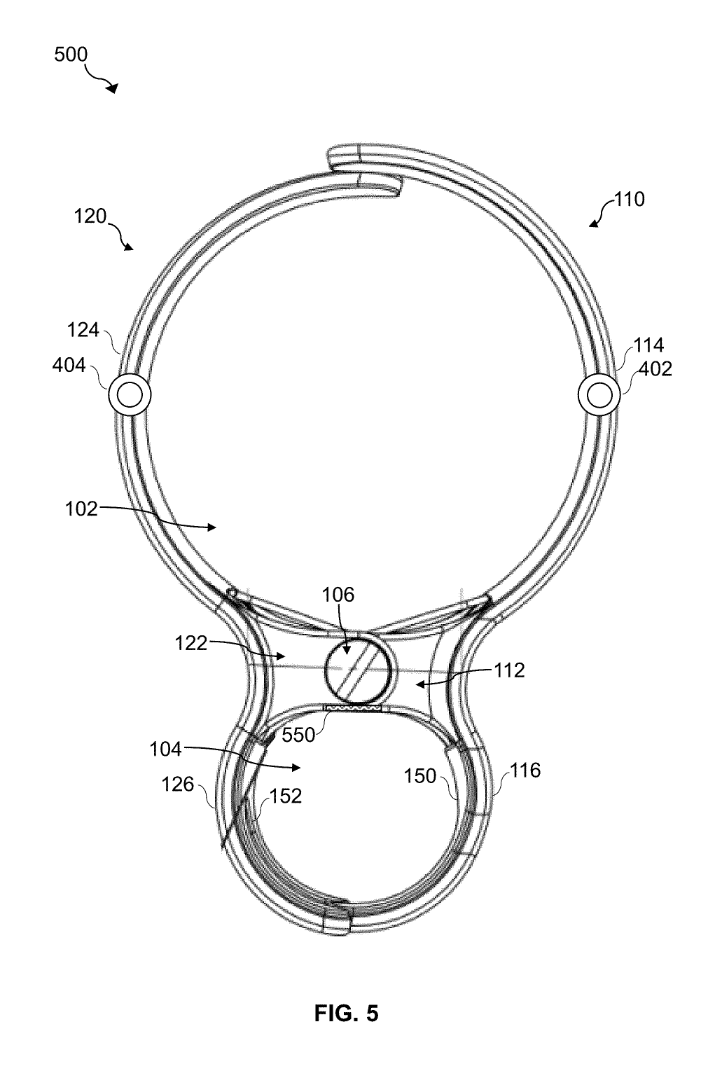

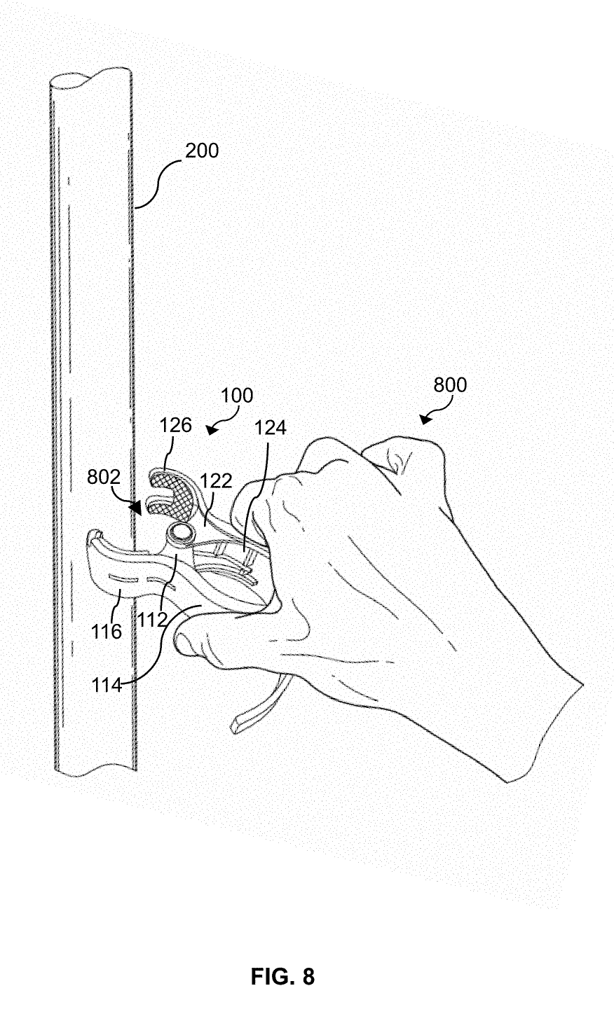

Turning to FIG. 4, a method for removably mounting a beverage-container holder 400 is illustrated. Blocks 402 to 406 describe mounting of the mountable beverage-container holder 100 to the fixed object 200. At block 402, a manual force is applied to the mountable beverage-container holder 100 such that it is urged to proceeds from open configuration to closed configuration. In the present embodiment, as illustrated in FIG. 8, this manual force involves a hand 800 applying a squeezing force to rotate the first front arm 114 and the second front arm 124 towards one another against the force of the mechanical bias 108. In this way, a space 802 is opened up between the ends of the first rear arm 116 and the second rear arm 126.

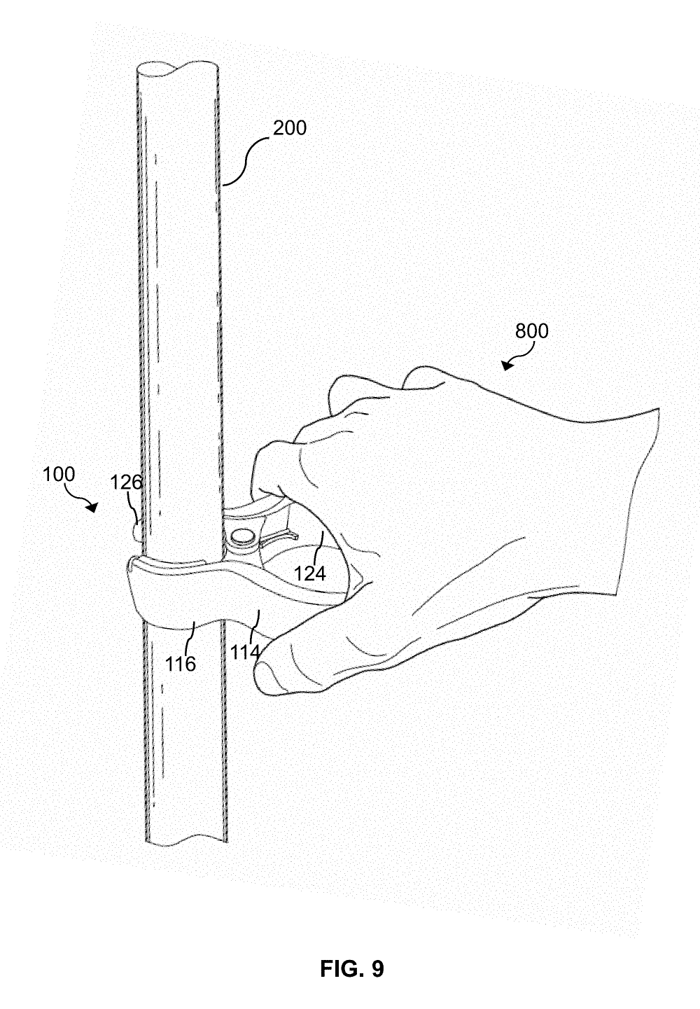

At block 404, as illustrated in FIG. 9, the mountable beverage-container holder 100 is brought to the fixed object 200 (in this case a pole), such that the fixed object 200 passes through the space between the first rear arm 116 and the second rear arm 126, and into the rear channel 104.

At block 406, as illustrated in FIG. 9, the manual force is abated (for example, the hand 800 stops applying the squeezing force) and the force provided by the mechanical bias 108 causes the first rear arm 116 and the second rear arm 126 to each press against the fixed object 200 in a semi-closed configuration. In this way, the mountable beverage-container holder 100 is securely mounted to the fixed object 200 and capable of receiving the beverage-container 300 to hold in the front channel 102.

Blocks 408 to 410 describe dismounting of the mountable beverage-container holder 100 from the fixed object 200. At block 408, with no beverage-container 300 held in the front channel 102, a manual force is applied to the mountable beverage-container holder 100 such that it proceeds from the semi-closed configuration to the open configuration. In the present embodiment, this manual force involves rotating the first front arm 114 and the second front arm 124 towards one another against the force of the mechanical bias 108.

At block 410, the mountable beverage-container holder 100 is pulled away from the fixed object 200, such that the fixed object 200 passes from the rear channel 104 and through the space between the first rear arm 116 and the second rear arm 126.

While the present embodiments illustrate the front channel 102 and the rear channel 104 forming a substantially circular horizontal shape, it is contemplated that the front channel 102 and the rear channel 104 can have any suitable shape to cooperate with the shape of the beverage-container 300 and fixed object 200, respectively. For example, forming a square shaped channel. As another example, the front arms 114, 124, and/or the rear arms 116, 126 can have a substantially-flat vertical shape, like jaws of a vise.

In further embodiments, the mountable beverage-container holder 100 can be collapsible for easier storage and portability. In the exemplary embodiment illustrated in FIG. 5, a mountable beverage-container holder 500 includes a first hinge 402 located on the first front arm 114 and a second hinge 404 located on the second front arm 124. In this way, the end portions of the front arms 114, 124 can fold in towards the hubs 112, 122 to provide a smaller horizontal footprint. In further embodiments, there can be two or more hinges per front arm 114, 124. In further embodiments, the rear arms 116, 126 can also include hinges. In yet further embodiments, the front arms 114, 124 and/or rear arms 116, 126 can be at least partially telescopic. In some cases, the first member 110 and/or the second member 120 can also include, or can be at least partially comprised of, a magnetic material 550 to assist in retaining the beverage-container holder to the fixed object or retaining the beverage-container in the front channel 102.

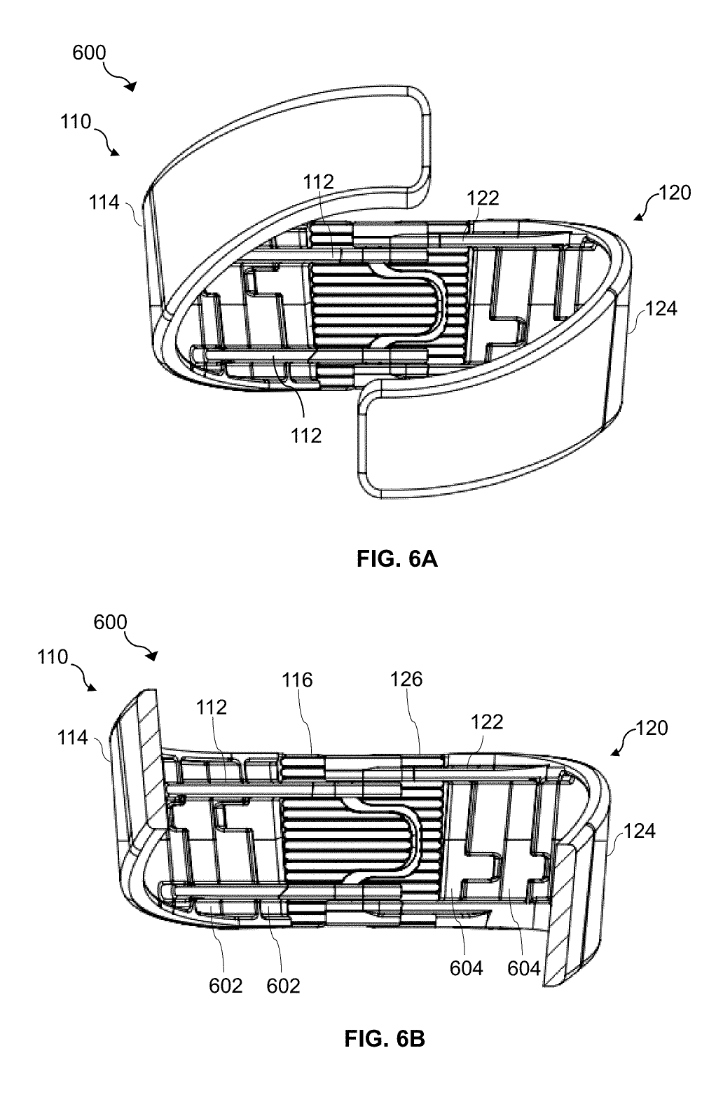

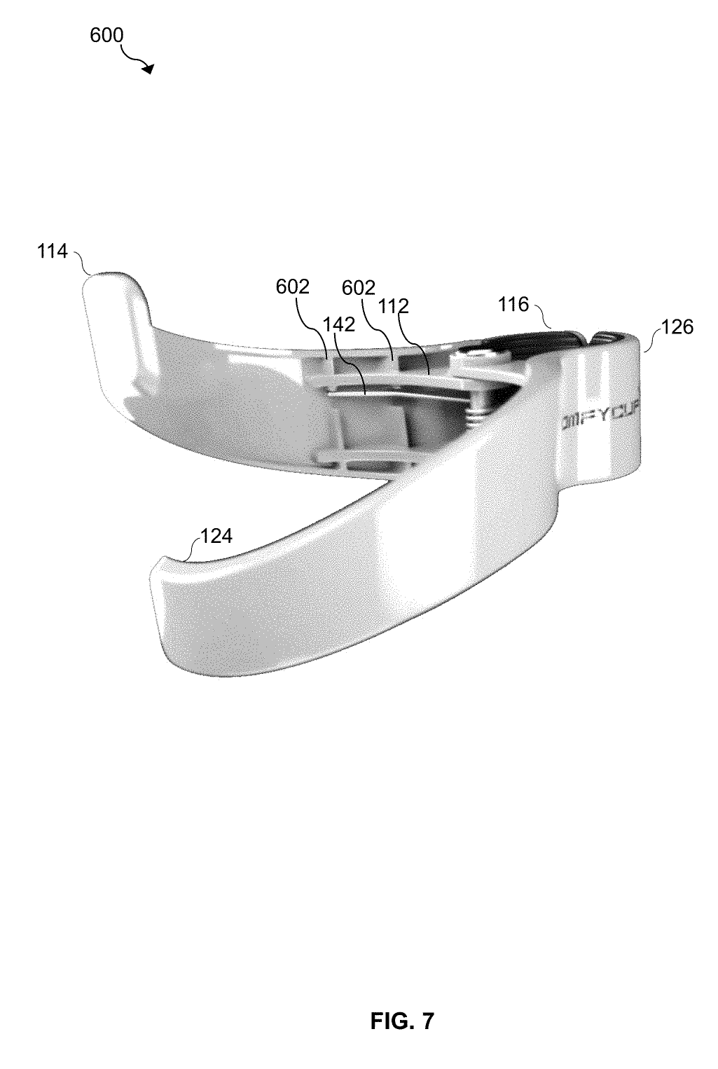

In further embodiments, the mountable beverage-container holder 100 can include support structures to assist in contending against the forces experienced by the beverage-container holder 100. In the exemplary embodiment illustrated in FIGS. 6A, 6B, and 7, the first front arm 114 includes one or more first transverse support ribs 602 and the second front arm 124 includes one or more second transverse support ribs 604. In this case, the transverse ribs 602, 604 are particularly helpful to provide extra support against the forces from the spring arms 142, 144 on the front arms 114, 124. In further embodiments, other support structure can be provided on the front arms 114, 124, rear arms, 116, 126, or hubs 112, 114; for example, longitudinal ribs, crossed ribs, or the like.

Advantageously, the embodiments described herein allow users to securely and removably mount a beverage-container holder to a fixed-object in a vehicle; permitting the users to participate and think about other activities during their commute, instead of just holding their beverage. The embodiments described herein are intended to be able to withstand the pressures of transportation, such as remaining secure during emergency stops and non-uniform motion. In non-limiting exemplary cases, Applicant has determined that the mountable beverage-container holder 100 can hold a beverage-container weighing up to a kilogram. In non-limiting exemplary cases, Applicant has determined that the mountable beverage-container holder 100 can be mounted to a fixed object 200 comprising a pole of between approximately 9 to 11 centimetres.

Advantageously, the embodiments described herein are intended to provide a beverage-container holder that can be durable, light-weight, easy-to-transport, and impact resistant. In a non-limiting example, Applicant determined that the beverage-container holder of the present embodiments can have a light weight of approximately 50 grams. Further advantageously, the embodiments described herein allow users to quickly and easily mount the beverage-container holder without having to tighten a screw or other fastener, or having to slide it down from an end of the fixed object. In some cases, Applicant determined that the beverage-container holder described herein can be mounted reliably in under three seconds. Further, it is intended that the beverage-container holder described herein can be mounted with one-handed operation without undue difficulty. Further, it is intended that the beverage-container holder described herein may be mounted by feel, without necessarily requiring sight of the fixed object.

Advantageously, the beverage-container holder of the present embodiments can have an effective locking mechanism. The beverage-container holder will be effectively “locked on to” the fixed object while the front channel 102 is receiving the beverage-container because, in order to dismount the beverage-container holder, the beverage-container must be removed from the front channel 102 such that the front arms 114, 124 can be rotated towards each other, creating the space in the rear arms 116, 126. Accordingly, it is intended that the user can be assured that the beverage-container holder is locked in place on the fixed object while receiving the beverage-container.

In the present embodiments, there is a single set of complementary members, the elements of each member being integral, and a single mechanical bias. This arrangement can be advantageously used for mounting the beverage-container holder and grasping the beverage-container. This arrangement, advantageously, is intended to reduce parts and complexity for production and manufacturing, and is intended to reduce the likelihood of failure of the holder. Also advantageously, the front arms 114, 124 can serve the dual purpose of receiving the beverage-container and providing handles for rotating the rear arms 116, 126 to mount the beverage-container holder 100; thus, reducing the number of necessary parts.

In various embodiments, the first member 110 and the second member 120, and the various components therein, can have any suitable width and height as long as there is sufficient material to reliably mount the beverage container to the fixed object.

While the embodiments described herein generally describe the fixed object as part of a vehicle, it is understood that the fixed object can be any suitable fixed object; for example, a pole for a lamp in a dwelling.

Although the foregoing has been described with reference to certain specific embodiments, various modifications thereto will be apparent to those skilled in the art without departing from the spirit and scope of the invention as outlined in the appended claims.

1. A beverage-container holder removably mountable to a fixed object for holding of a beverage-container, the beverage-container holder comprising:
a first member comprising a first front arm, a first hub, and a first rear arm;
a complementary second member comprising a second front arm, a second hub, and a second rear arm;
a fastener for rotatably adjoining the first hub to the second hub such that the first front arm horizontally opposes the second front arm forming a front channel therebetween configured to receive the beverage-container when the beverage-container holder is mounted on the fixed object, and such that the first rear arm horizontally opposes the second rear arm forming a rear channel therebetween configured to receive the fixed object;
a mechanical bias forcing the first front arm and the second front arm rearwards such that the first rear arm moves towards the second rear arm, the first rear arm separating from the second rear arm and defining a space therebetween when a manual force is applied to rotate the first front arm towards the second front arm against the mechanical bias, the beverage-container holder mountable on the fixed object by positioning the beverage-container holder such that the fixed object passes through the space into the rear channel, and releasing of the manual force such that the front channel can receive the beverage container.

2. The beverage container holder of claim 1, wherein the beverage-container holder is dismountable from the fixed object when the front channel is no longer receiving the beverage-container, a manual force is applied to rotate the first front arm towards the second front arm against the mechanical bias, and the beverage-container is pulled away from the fixed object such that the fixed object passes through the space out of the rear channel.

3. The beverage container holder of claim 1, wherein the first rear arm and the second rear arm have a substantially arcuate shape.

4. The beverage container holder of claim 3, wherein the fixed object has a substantially cylindrical shape and wherein the first rear arm and the second rear arm form the rear channel with a substantially circular profile.

5. The beverage container of claim 4, wherein the first rear arm comprises one or more first fingers and the second rear arm comprises one or more second fingers, and wherein the first fingers are interlocking with the second fingers.

6. The beverage container holder of claim 1, wherein the first front arm and the second front arm have a substantially arcuate shape.

7. The beverage container holder of claim 6, wherein the first front arm has a gradual upward profile along a vertical direction and the second front arm has a gradual downward profile along the vertical direction.

8. The beverage container holder of claim 7, wherein the first front arm and the second front arm form the rear channel having a downwards pointing substantially conical profile.

9. The beverage container holder of claim 1, wherein the first member comprises a single integral member and the second member comprises a separate single integral member.

10. The beverage container holder of claim 1, wherein the mechanical bias comprises a torsion spring.

11. The beverage container holder of claim 10, wherein the torsion spring having a spring rate of between approximately 0.1 inch-lbs/degree and 0.2 inch-lbs/degree.

12. The beverage container holder of claim 1, wherein the first front arm and the second front arm, the first rear arm and the second rear arm, or both, comprise a high-friction material.

13. The beverage container holder of claim 1, wherein the first front arm and the second front arm each comprise at least one hinge such that the first front arm and the second front arm are collapsible.

14. The beverage container holder of claim 1, wherein the first front arm and the second front arm each comprise a support structure.

15. The beverage container holder of claim 14, wherein the support structure comprises one or more transverse ribs.

16. A method for removably mounting a beverage-container holder to a fixed object to hold a beverage-container, the method comprising:
mounting the beverage-container holder to the fixed object, comprising:
applying a manual force to rotate a first front arm of a first member towards a second front arm of a second member against a mechanical bias to create a space between a first rear arm of the first member and a second rear arm of the second member, the first front arm horizontally opposes the second front arm forming a front channel therebetween configured to receive the beverage-container, the first rear arm horizontally opposes the second rear arm forming a rear channel therebetween configured to receive the fixed object, the rotation about a pivot comprising a first hub of the first member rotatably adjoined to a second hub of the second member;
positioning the beverage-container holder such that the fixed object passes through the space and in to the rear channel;
releasing of the manual force; and
receiving the beverage-container in the front channel; and
dismounting the beverage-container holder from the fixed object, comprising:
removing the beverage-container from the front channel;
applying the manual force to rotate the first front arm towards the second front arm against the mechanical bias to create the space between the first rear arm and the second rear arm; and
positioning the beverage-container holder such that the fixed object passes through the space and out of the rear channel.

17. The method of claim 16, further comprising increasing a clamping force of the first rear arm and the second rear arm against the fixed object when the front channel receives the beverage-container having a tapered profile.

18. The method of claim 16, wherein the fixed object has a cylindrical profile, and wherein the method further comprises automatically adjusting a diameter of the rear channel to a size of the fixed object.

19. The method of claim 16, wherein applying the manual force to rotate the first front arm towards the second front arm twists against the force of the mechanical bias, the mechanical bias being a torsion spring.

20. The method of claim 16, wherein mounting the beverage-container holder to the fixed object further comprising opening a collapsible portion of each of the first front arm and the second front arm.
